(19) United States
(12) Patent Application Publication
(10) Pub. No.: US 2016/0023433 A1
(43) Pub. Date: Jan. 28, 2016

(54) THERMOPLASTIC COMPOSITE PREPREG FOR AUTOMATED FIBER PLACEMENT

(71) Applicant: ADC Acquisition Company, Schenectady, NY (US)

(72) Inventors: Robert J. Langone, Clifton Park, NY (US); David E. Hauber, Troy, NY (US); Zachary A. August, Clifton Park, NY (US)

(21) Appl. No.: 14/848,637

(22) Filed: Sep. 9, 2015

Related U.S. Application Data
(63) Continuation-in-part of application No. 13/718,192, filed on Dec. 18, 2012.
(60) Provisional application No. 61/578,386, filed on Dec. 21, 2011.

(51) Int. Cl. B32B 5/26; B29C 70/20; B29C 35/08; B29C 70/38

(52) U.S. Cl. CPC B32B 5/26; B29C 70/386; B29C 70/20; B29C 35/0805; B29K 2105/0881

(57) ABSTRACT

An improved thermoplastic composite prepreg tape is disclosed. The prepreg tape is optimized for high-speed, high quality in-situ consolidation during automated fiber placement. Embodiments of the prepreg tape have uniform dimensions (cross section, width, and thickness), uniform energy absorption, uniform surface roughness, and sufficient resin at the surface to affect a bond between layers. A scattering agent is used in a polymer surface layer to enable a combination of scattering and absorption in the polymer surface layer.

### CROSS-REFERENCE TO RELATED APPLICATIONS

The present patent document is a continuation-in-part of U.S. patent application Ser. No. 13/718,192, filed Dec. 18, 2012, titled “THERMOPLASTIC COMPOSITE PREPREG FOR AUTOMATED FIBER PLACEMENT”, the disclosure of which is incorporated herein by reference. U.S. patent application Ser. No. 13/718,192 claims priority to U.S. Provisional Patent Application Ser. No. 61/578,386, filed on Dec. 21, 2011, which is incorporated herein by reference as well.

### FIELD OF THE INVENTION

The present invention relates generally to composite materials, and, more particularly, to an improved thermoplastic composite prepreg for automated fiber placement.

### BACKGROUND

Reinforced thermoplastic and thermoset materials have wide application in, for example, the aerospace, automotive, industrial/chemical, and sporting goods industries, etc. Thermoplastic or thermosetting resins are impregnated into reinforcing fibers to form a “prepreg” tape that is used to form completed structures. Thermoplastic prepregs may be melt bonded together in-process avoiding the expensive and time-consuming procedure of curing that is required for thermoset prepregs. These thermoplastic prepreg tapes are growing in popularity among all segments of the composites industry due to their higher performance and versatility. However, process rates, surface finish, and some properties such as inter-laminar shear strength are lower for in-process consolidated thermoplastic prepregs. It is therefore desirable to have an improved thermoplastic composite prepreg for automated fiber placement.

### SUMMARY

Embodiments of the present invention provide an improved thermoplastic composite prepreg for automated fiber placement. The prepreg in accordance with an embodiment of the present invention has a substantially uniform geometry. In some embodiments, a polymer surface layer is disposed on a composite tape. A scattering agent is disposed in the polymer surface layer to provide both scattering and absorption, for example, from electromagnetic waves, such as light from a laser. The scattering agent improves absorption of energy by the polymer surface layer. In addition, the scattering agent may also provide some absorption to further provide an even, distributed heating of the polymer surface layer, which allows for more effective formation of multilayer composite shapes. Methods in accordance with embodiments of the present invention create structures using this prepreg without the need for costly and time-consuming autoclave processes.

In one embodiment, a multilayered composite material is provided, the material comprising, a fiber tape comprising fibers held together with a thermoplastic polymer matrix, a susceptor layer disposed on a first side of the fiber tape, and a polymer surface layer disposed on the susceptor layer.

In another embodiment, a multilayered composite material is provided, the material comprising, a fiber tape comprising fibers held together with a thermoplastic polymer matrix, a polymer surface layer disposed on the fiber tape, wherein a susceptor is intermixed in the polymer surface layer.

In another embodiment, a multilayered composite material is provided, the material comprising, a fiber tape comprising fibers held together with a thermoplastic polymer matrix, a first susceptor layer disposed on a first side of the fiber tape, a first polymer surface layer disposed on the first susceptor layer, a second susceptor layer disposed on a second side of the fiber tape, and a second polymer surface layer disposed on the second susceptor layer.

In another embodiment, a multilayered composite material suitable to be bonded by a laser is provided, comprising: a prepreg fiber tape comprising fibers held together with a thermoplastic polymer matrix; a polymer surface layer disposed on the prepreg fiber tape; and a scattering agent disposed within the polymer surface layer, wherein the scattering agent comprises a plurality of discrete particles that are substantially uniformly distributed throughout the polymer surface layer, and wherein the polymer surface layer and the thermoplastic polymer matrix are comprised of an identical polymer.

In another embodiment, a method of forming a composite object is provided comprising: applying a plurality of multilayered composite material windings to a mandrel, wherein the plurality of multilayered composite material windings comprise: a prepreg fiber tape comprising fibers held together with a thermoplastic polymer matrix; a polymer surface layer disposed on the prepreg fiber tape; and a scattering agent disposed within the polymer surface layer, wherein the scattering agent comprises a plurality of discrete particles that are substantially uniformly distributed throughout the polymer surface layer, and wherein the polymer surface layer is comprised of the same polymer as the thermoplastic polymer matrix; applying laser energy to the multilayered composite material as it is applied to the mandrel; and compacting the multilayered composite material after the laser energy has been applied.

In another embodiment, a method of making a multilayered composite material, comprising: applying a scattering agent to a polymer to be used as a polymer surface layer; and applying the polymer surface layer to a prepreg fiber tape comprising fibers held together with a thermoplastic polymer matrix, wherein the thermoplastic polymer matrix and the polymer surface layer comprise an identical polymer.

### BRIEF DESCRIPTION OF THE DRAWINGS

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering may represent like elements.

FIG. 1 shows a prior art prepreg tape with a non-uniform geometry.

FIG. 2 shows a prior art prepreg tape with uneven resin distribution.

FIG. 3 shows a block diagram of the process of application of a prepreg tape.

FIG. 4A is a block diagram of a prepreg tape in accordance with an embodiment of the present invention.

FIG. 4B is a block diagram of a prepreg tape in accordance with an alternative embodiment of the present invention.

FIG. 5 shows multiple layers of a prepreg tape in accordance with an embodiment of the present invention.

FIG. 6 is a block diagram of a prepreg tape in accordance with an alternative embodiment of the present invention.

FIG. 7 shows a cross-section view of a multilayered composite material utilizing a scattering agent in accordance with additional embodiments.

FIG. 8A shows detailed cross-section views of a multilayered composite material utilizing a scattering agent in accordance with some embodiments.

FIG. 8B shows a detailed cross-section view of a multilayered composite material utilizing a scattering agent in accordance with some embodiments.

FIG. 8C shows a detailed cross-section view of a multilayered composite material utilizing a scattering agent in accordance with some embodiments.

FIG. 8D shows a detailed cross-section view of a multilayered composite material utilizing a scattering agent in accordance with some embodiments.

FIG. 8E shows a detailed cross-section view of a multilayered composite material utilizing a scattering agent in accordance with some embodiments.

FIG. 8F shows a detailed cross-section view of a multilayered composite material utilizing a scattering agent in accordance with some embodiments.

FIG. 9 is a graph showing a relationship between volume resistivity and carbon black content.

FIG. 10 is a graph showing a relationship between absorbance and wavelength for dyed particles.

FIG. 11 is a graph showing scattering power as a function of particle size for rutile titanium oxide.

FIG. 12 is a flowchart indicating process steps for embodiments of the present invention.

### DETAILED DESCRIPTION

Embodiments of the present invention provide an improved thermoplastic composite prepreg tape. The prepreg tape is optimized for high-speed, high quality in-situ consolidation during automated fiber placement. Embodiments of the prepreg tape have substantially uniform dimensions (cross section, width and thickness, etc.), substantially uniform energy absorption, substantially uniform surface roughness, and sufficient resin at the surface to affect a bond between layers. Embodiments of the present invention provide a multilayered composite material. The multilayered composite material comprises a fiber tape comprising: fibers held together with a thermoplastic polymer matrix; a susceptor layer disposed on at least one side of the fiber tape; and a polymer surface layer disposed on the susceptor layer. Benefits include being able to fabricate components (e.g. aircraft parts and the like) using automated fiber placement without the need for costly and time-consuming post processes such as an autoclave.

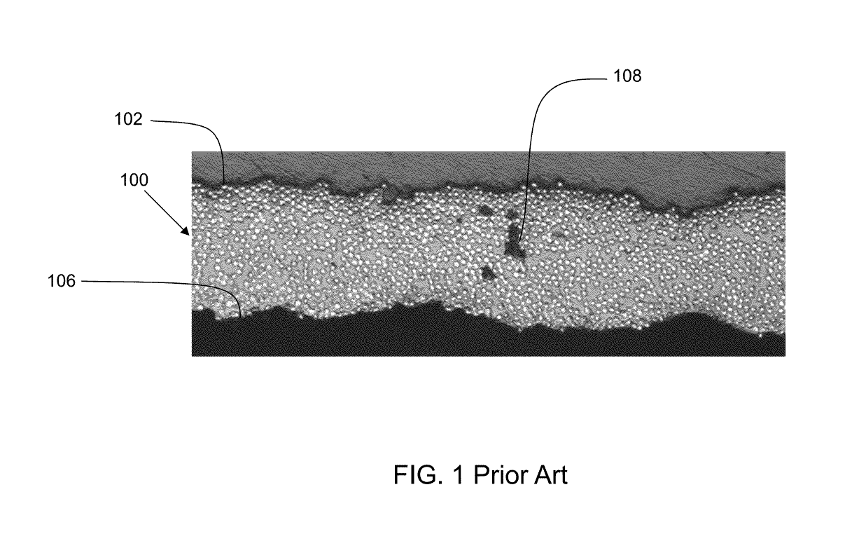

FIG. 1 shows a prior art prepreg tape 100 with a non-uniform geometry. As can be seen in FIG. 1, the top edge 102 of the tape 100 and bottom edge 106 of the tape are relatively non-uniform (uneven). The non-uniform surface of prepreg tape 100 necessitates that the tape be heated through the thickness so that it will conform to the previous ply to form a good bond. Furthermore, one or more voids 108 may be present in the tape 100. The presence of voids such as 108 may require significant time under pressure and temperature for the entrapped air to diffuse. Therefore, a prepreg tape of this nature may not be economical for in-situ Automated Fiber Placement (AFP).

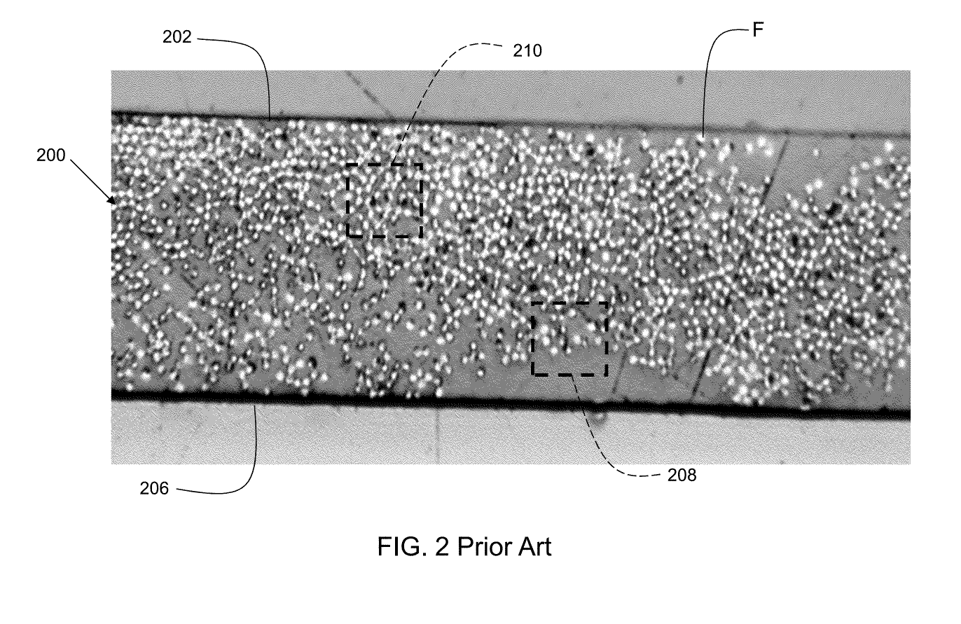

FIG. 2 shows a prior art prepreg tape 200 with uneven resin distribution. The top edge 202 of the tape 200 and bottom edge 206 of the tape are relatively smooth, compared with that of tape 100 of FIG. 1. The composite fibers within tape 200 appear as white dots, denoted generally as “F.” Tape 200 has a relatively uneven fiber distribution. For example, cross-sectional region 208 has relatively few fibers as compared with similarly sized cross-sectional region 210. For a given cross-sectional region, it is desirable to have a relatively consistent fiber density. The non-uniform distribution of the fibers of tape 200 can result in uneven heating, which can further result in structural defects or increased process time for preventing such defects.

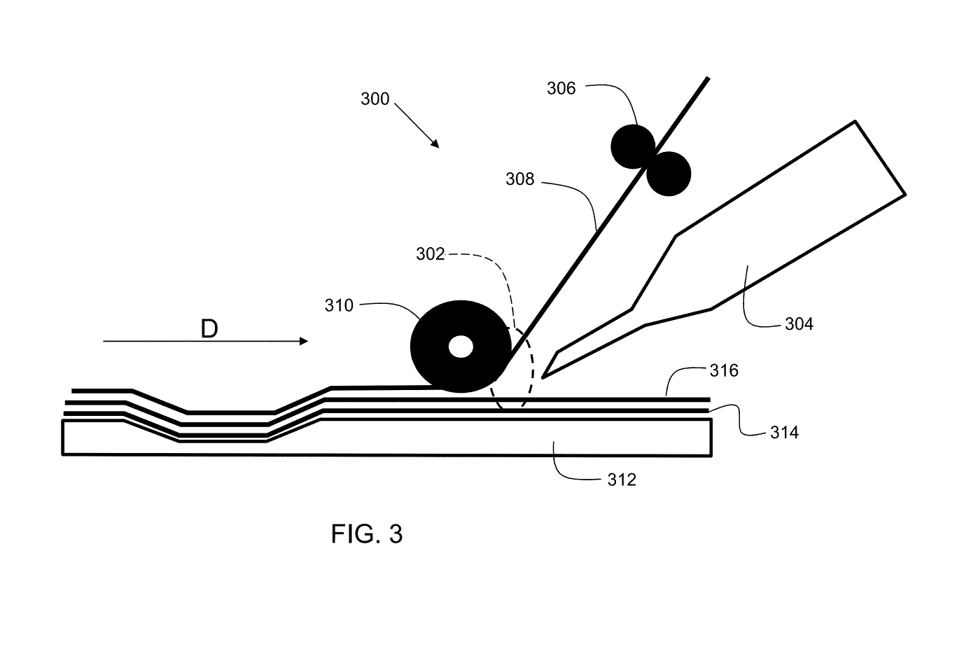

FIG. 3 shows a block diagram 300 of the application of a prepreg tape in an automated fiber process (AFP). Fiber tapes are placed over a tool 312 to form a desired component shape. As shown in FIG. 3, tape 314 and tape 316 have been previously applied. Tape 308 is currently being applied. A heat source 304 applies heat to the currently applied tape 308 as it is dispensed from tape feed 306, and also applies heat to the previously applied tape 316. The heat source 304 may be a laser or any other suitable device or means. The area where heat is applied is referred to as a Heat Affected Zone (HAZ) 302. The HAZ raises both the currently applied tape 308 and the previously applied tape 316 to a temperature suitable to affect a bond between the layers. Currently applied tape 308 is then compacted to (pressed against) previously applied tape 316 by compaction roller 310, causing a bond to form between tape 308 and tape 316.

The larger the HAZ, the more time it takes to cool and the more residual stresses are induced. The prepreg shrinks as it cools due to its Coefficient of Thermal Expansion (CTE) at varying rates depending on factors, non-limiting examples of which include the type of fiber, matrix, and the direction (e.g. fiber direction or cross-fiber direction) in which shrinkage is measured. The currently applied tape 308, heat source 304, and associated tape supply mechanism travel in direction D to apply the tape. In some embodiments, this motion may be repeated as necessary or desirable to build up a composite shape.

One way to achieve a small HAZ 302 is to use a high intensity energy source such as a laser. If the laser energy is of a wavelength that is absorbed by the polymer (such as CO₂ lasers at 10.6 μm), then the high intensities that are needed for high process rates tend to vaporize or otherwise damage the polymer on the surface resulting in poor bond quality. Therefore, with the non-uniform fiber distribution and/or surfaces of the prior art prepreg tapes, uneven heating and poor bond quality can result. If the laser energy is of a wavelength to which the polymer is transparent (such as, for example, diode lasers or fiber lasers at 1060 nm) then an absorbing material is needed to create the HAZ.

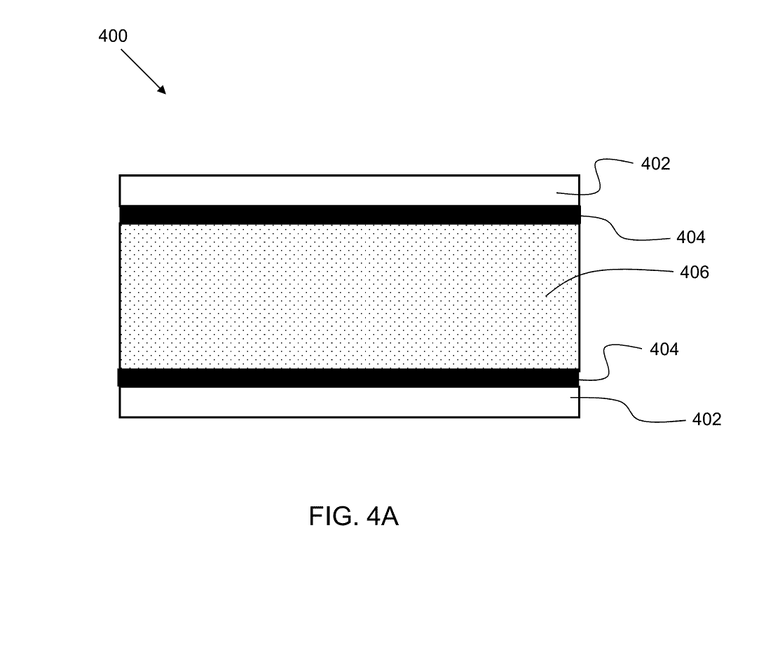

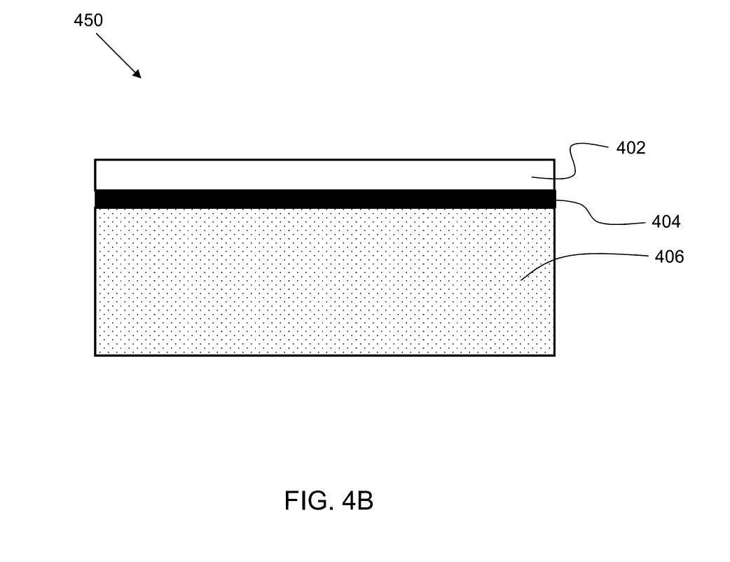

FIG. 4A is a block diagram of a prepreg tape 400 in accordance with an embodiment of the present invention. The prepreg tape 400 comprises fiber tape 406, which is a tape comprised of reinforcement fibers held together by a thermoplastic polymer matrix. In one embodiment, the fiber tape 406 is comprised of carbon fibers in resin. In one embodiment, the resin is comprised of PEEK (Polyether ether ketone). In other embodiments, the resin may comprise virtually any thermoplastic resin including without limitation: PEKK (polyetherketoneketone), PEK (polyetherketone), PAEK(Polyarlyetherkeone), PPS (Polyphenylene Sulfide), PI (Polyimide), TPI (Thermoplastic Polyimide), PEI (Polyetherimide), PP (Polypropylene), PE (Polyethylene), PBT (Polybutylene Terephthalate), FEP (Fluorinated Ethylene Propylene), PFA (Perfluoroalkoxy), PVDF (Polyvinylidene floride), TFE (Polytetrafluoroethylene), ETFE (Poly(Ethylene Tetrafluoroethylene)), PET (Polyethylene Terephthalate), TPU (Thermoplastic Polyurethane), PA (Polyamide), PAI (Polyamide-Imide), or any combination thereof. In other embodiments, the fiber tape 406 may have fibers comprised of glass, ceramic, aramid, any combination thereof, or any other material that has high strength, stiffness, energy absorption, or any other desirable property. In one embodiment, the carbon fibers have a diameter ranging from approximately 6 micrometers to approximately 8 micrometers. It will be recognized that any other feasible dimensions are included within the scope of the invention. The fibers of tape 406 may be continuous fibers, woven fibers, braided fibers, discontinuous fibers, fiber mat, any combination thereof, or any other suitable form. The fiber tape 406 may have a thickness ranging from approximately 130 micrometers to approximately 150 micrometers. It will be recognized that any other feasible thicknesses are included within the scope of the invention. In one embodiment, the fibers of tape 406 are continuous unidirectional fibers. It will be recognized that any other feasible fiber arrangements are included within the scope of the invention. A susceptor (absorber) layer 404 is disposed on each side the fiber tape 406. A polymer surface layer 402 is disposed on each of the susceptor layers 404.

The susceptor layer 404 absorbs the energy from a laser or other source to create the heat needed to bond adjacent layers of the prepreg tape 400. The choice of material for the susceptor may depend, in part, on the energy source used for creating the HAZ. For example, if laser energy at 1060 nm is used, the absorber 404 may be comprised of carbon black, nanotubes, nanoclay, graphene, nanoparticles, whiskers, carbon fiber dust, or any other suitable means. CLEARWELD coating (Produced by Gentex, Carbondale, PA) may also be used, as it contains energy absorbing materials designed for operating in the 940 nm-1100 nm wavelength range. Clearweld coatings form thin, uniform layers of the energy absorbing materials onto the fiber tape 406. When laser energy is applied to the area that has been coated, the Clearweld material absorbs this energy and converts it to heat. This results in a localized melting of the prepreg tape layers and the formation of a weld.

A variety of methods may be used for making polymer surface layer 402. Such methods may include, but are not limited to, extrusion, film coating, powder coating, casting, solution coating, plasma spray, flame spray, sintering, vapor deposition, any combination thereof, or any other suitable means. In one embodiment, the polymer surface layer 402 has a thickness ranging from approximately 1 micrometer to approximately 15 micrometers, and a surface roughness, Ra, ranging from approximately 0.1 micrometers to approximately 1.3 micrometers. It will be recognized that any other feasible thicknesses and surface roughnesses are included within the scope of the invention. The polymer surface layer may be comprised of PE (Polyethylene), PP (Polypropylene), PET (Polyethylene terephthalate), PEEK (Polyether ether ketone), PEKK (Polyetherketoneketone), PI (Polyimide), PAI (Polyamide-imide), any combination thereof, or any other suitable polymer.

It is preferable to provide a uniform coating that achieves intimate contact with the surface to which it is being bonded, and has sufficient thickness to affect the bond, but not so thick as to adversely affect the performance of the overall structure by significantly reducing fiber volume fraction. Since the fibers produce the desirable strength and/or stiffness in a typical composite structure, it is desirable to maximize the amount of fibers available per unit volume. This parameter is referred to as “fiber volume.”

FIG. 4B is a block diagram of a prepreg tape 450 in accordance with an embodiment of the present invention. Prepreg tape 450 is similar to prepreg tape 400 of FIG. 4A, except that prepreg tape 450 only has absorber 404 and polymer surface layer 402 on one side. This embodiment may be more economical for certain applications.

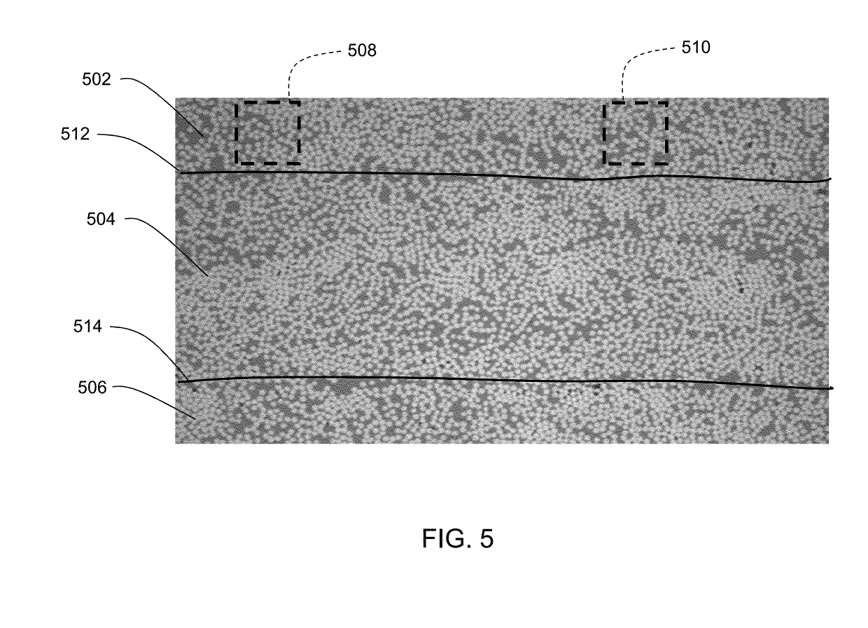

FIG. 5 shows multiple layers of a prepreg tape (such as 400 in FIG. 4A) bonded together in accordance with an embodiment of the present invention. Tape layer 502 is bonded to tape layer 504, which is in turn bonded to tape layer 506. The boundary 512 between tape layer 502 and tape layer 504 is substantially uniform, providing a good bonding surface. This also holds true for boundary 514 between tape layer 504 and tape layer 506. The fiber volume per unit area is relatively consistent. For example, the fiber volume in cross-sectional area 508 is similar to the fiber volume in cross sectional area 510.

In one embodiment, the fiber volume, which is a percentage of fiber volume to total volume for a given cross-sectional volume of the tape, ranges from 55% to 65% with one standard deviation ranging from about 2% to about 4%, and more preferably about 3%. It will be recognized that any other feasible fiber volumes are included within the scope of the invention.

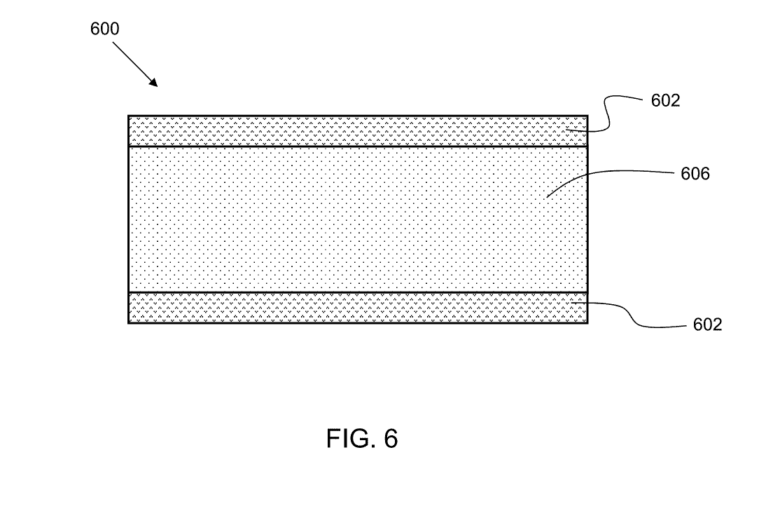

FIG. 6 is a block diagram of a prepreg tape 600 in accordance with an alternative embodiment of the present invention. In this embodiment, fiber tape 606 (which is similar to fiber tape 406 of FIG. 4A) has polymer surface layer 602 with a susceptor mixed into it. Hence, as compared with the embodiment of FIG. 4A, the susceptor here is intermixed in the polymer rich surface, not just under it. In this embodiment, the absorber is not concentrated at the surface of the prepreg as shown in the embodiment of FIG. 4A. As long as the susceptor is configured in such a way so as to provide uniform heating of the surface polymer layer, a bond is then able to form between layers without damage to the polymer or significant degradation of the physical properties of the laminate. In this embodiment, the susceptor may comprise carbon black, or any other suitable material that can be mixed with a polymer surface layer.

In some use cases, volume resistivity of the composite material is a concern. Certain situations require materials with very high volume resistivity. That is, materials that are good electrical insulators are needed in certain applications. Materials such as carbon black can considerably degrade volume resistivity. Thus, in some embodiments, a scattering agent may be disposed within a polymer surface layer. The scattering agent may comprise a plurality of discrete particles that are substantially uniformly distributed throughout the polymer surface layer. The polymer surface layer is disposed on a prepreg fiber tape comprising fibers held together with a thermoplastic polymer matrix. In embodiments, the polymer surface layer and thermoplastic polymer matrix utilize an identical polymer. The use of the same polymer in both layers provides benefits, such as a similar coefficient of thermal expansion (CTE) between the thermoplastic polymer matrix and the polymer surface layer.

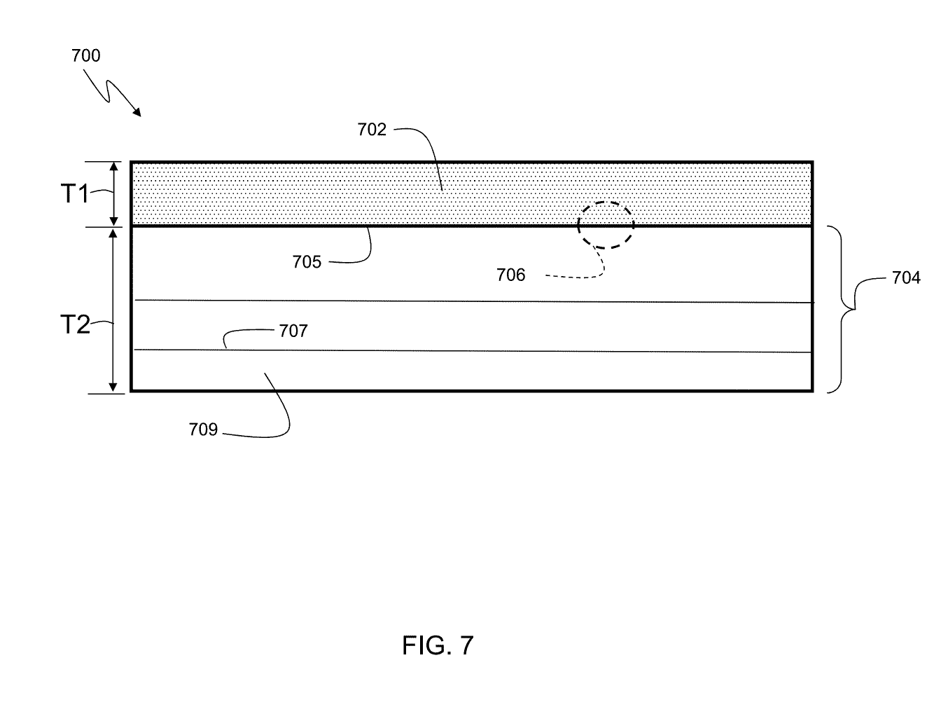

Referring now to FIG. 7, an example of a multilayered composite material 700 suitable to be bonded by a laser in accordance with embodiments of the present invention is shown. The multilayered composite material 700 comprises a polymer surface layer 702, which is disposed on a prepreg fiber tape 704. The prepreg fiber tape 704 comprises a plurality of fibers 707 disposed within a thermoplastic polymer matrix 709. In embodiments, the thermoplastic polymer matrix is comprised of at least one of PEEK, PEI, PEKK, PA, PP any other suitable polymer, or combination thereof. The fibers 707 may be comprised of carbon or any other suitable fiber. The polymer surface layer 702 may be comprised of the same material as thermoplastic polymer matrix 709. In some embodiments, the polymer surface layer 702 may be comprised of a different material from thermoplastic polymer matrix 709. The polymer surface layer 702 has a thickness T1 and the prepreg tape has a thickness T2. In embodiments, T2 is 10 to 50 times the thickness of T1. In some embodiments, T1 is about 10 micrometers and T2 has a value ranging from about 100 micrometers to about 500 micrometers, for example 400 micrometers.

Embodiments of the present invention apply a scattering agent dispersed within the polymer surface layer. The scattering agent serves to utilize light scattering to improve energy absorption. In many cases low electrical conductivity (high volume resistivity) in the structure is desirable such as for insulators and radio transparent antenna shields. Polymers typically have volume resistivity on the order of 10E14 to 10E18 ohm-cm and even low levels of carbon black could significantly decrease volume resistivity, resulting in undesirable effects. Embodiments of the present invention provide for increasing absorption of light while improving other characteristics, such as:
1) Using non-electrically conductive (typically low emissivity) materials to scatter light
2) Using thermochromic and/or thermotropic materials to control absorption of light energy
3) Using light absorbing dyes to improve absorption of the scattering means

Embodiments of the present invention may utilize powdered materials and take advantage of Mie scattering, with some modification. In theory, Mie scattering indicates that the maximum absorption of light scattered by particles occurs when the particle size is equal to the wavelength of the incident light for idealized perfect spherical particles. For example, 1.06 micrometer infrared light produced by an Nd:YAG (neodymium-doped yttrium aluminum garnet; Nd:Y₃Al₅O₁₂) laser would be optimally absorbed by particles 1.06 micrometers in diameter. However, it has been determined that the amount of light scattering depends on many factors including particle dispersion, material properties, and particle shape. Thus, in embodiments, a wavelength offset may be utilized, in which the wavelength of incident light may deviate from the Mie scattering theoretical value by a predetermined amount to account for the aforementioned factors.

The polymer used in the polymer surface layer 702 is not completely transparent to light, and thus has some absorption capabilities. The scattering agent serves to scatter incident light, thereby improving the absorption. For example, considering the polymer PEEK, an engineering polymer commonly used for in-situ automated fiber placement, attenuation data shows that most of the incident 1.06 micrometer infrared light is absorbed in 0.10 inch. Mie scattering from the scattering agent results in significant absorption through the thickness of the polymer since the scattered light has a long, tortuous path through the scattering agent infused polymer. The scattering agent is preferably well dispersed and has a sufficient volume (or weight) fraction to achieve this goal. In embodiments, the scattering agent includes discrete particles and does not include aggregates. In some embodiments, the scattering agent includes titanium oxide particles. In some embodiments, the titanium oxide particles are rutile titanium oxide particles. In some embodiments, the scattering agent comprises alumina (Al₂O₃). In other embodiments, the scattering agent comprises silica (SiO₂). In yet other embodiments, the scattering agent comprises glass microballoons. Such mircoballoons are available from a variety of manufacturers, such as 3M Corporation. In some embodiments, the polymer surface layer is melt miscible with the thermoplastic polymer matrix, such that the polymer surface layer and the thermoplastic polymer matrix form a homogeneous layer at the boundary 705 during the heating process.

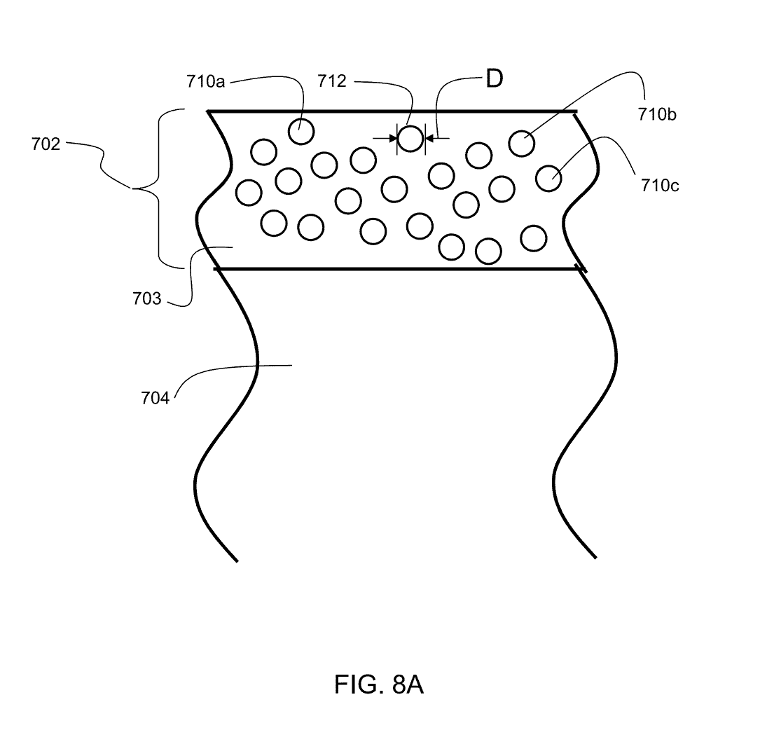

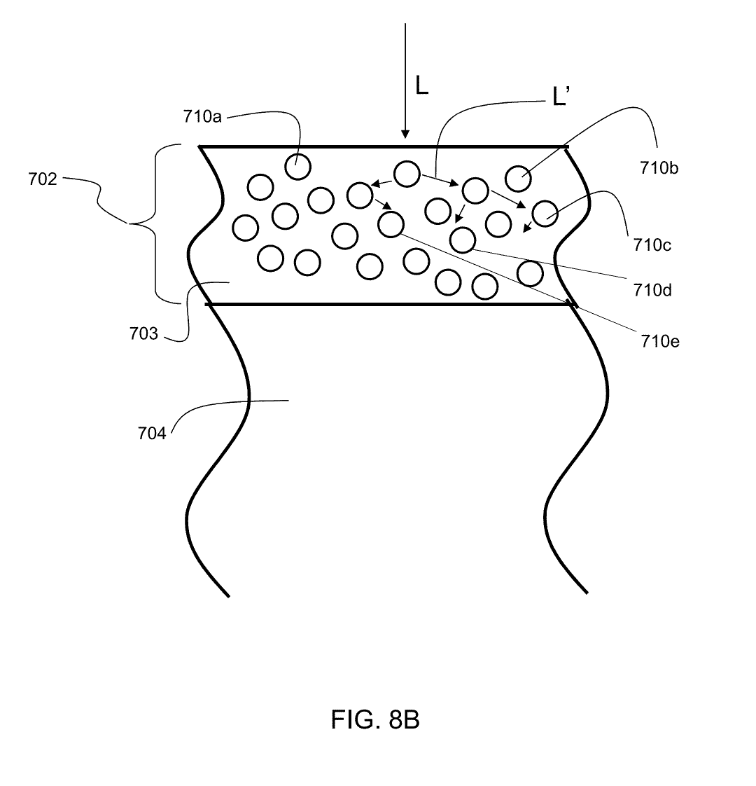

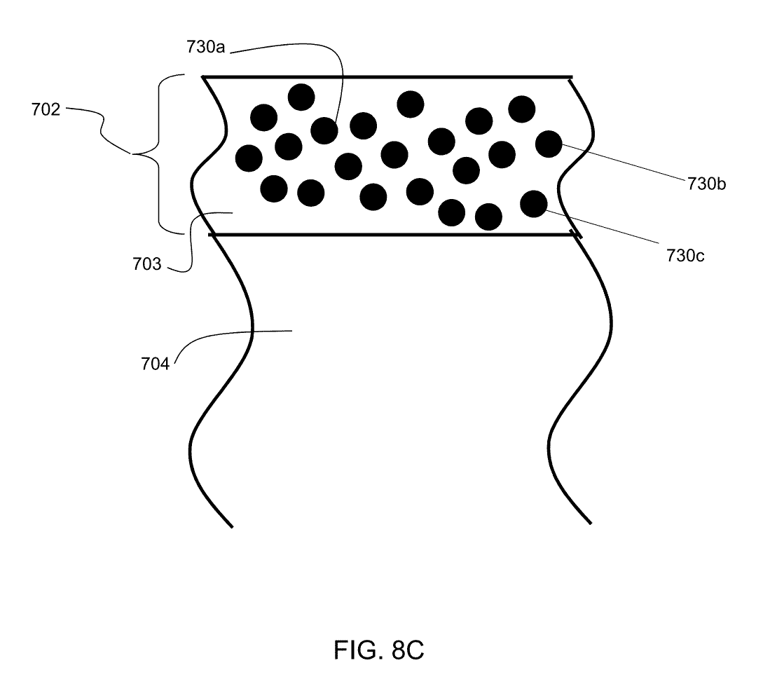

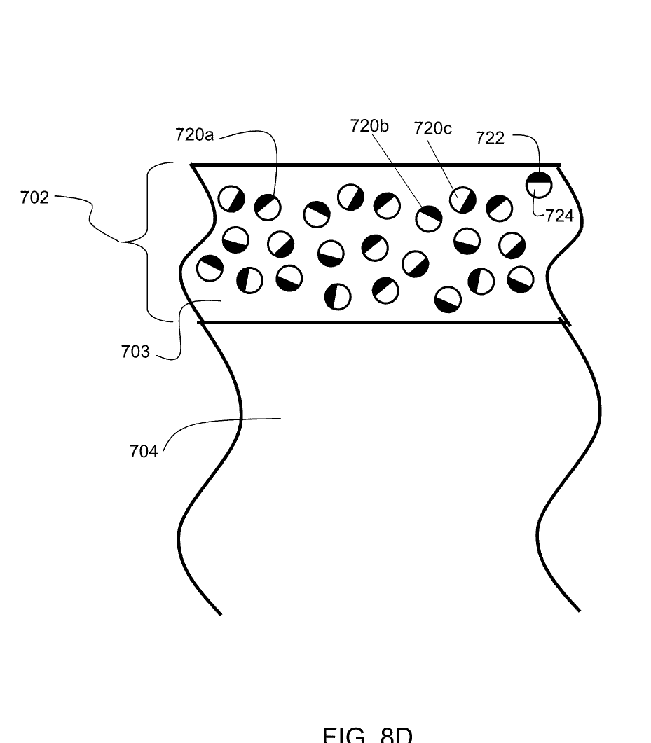

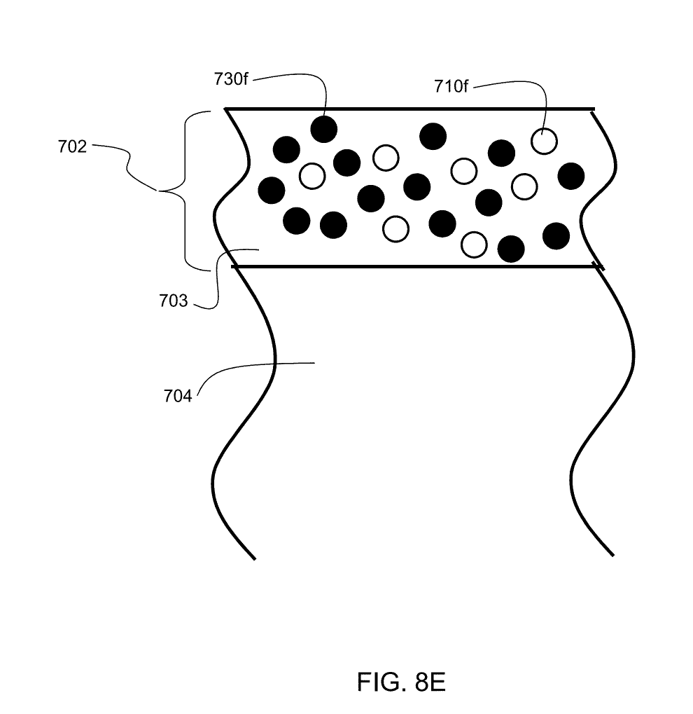

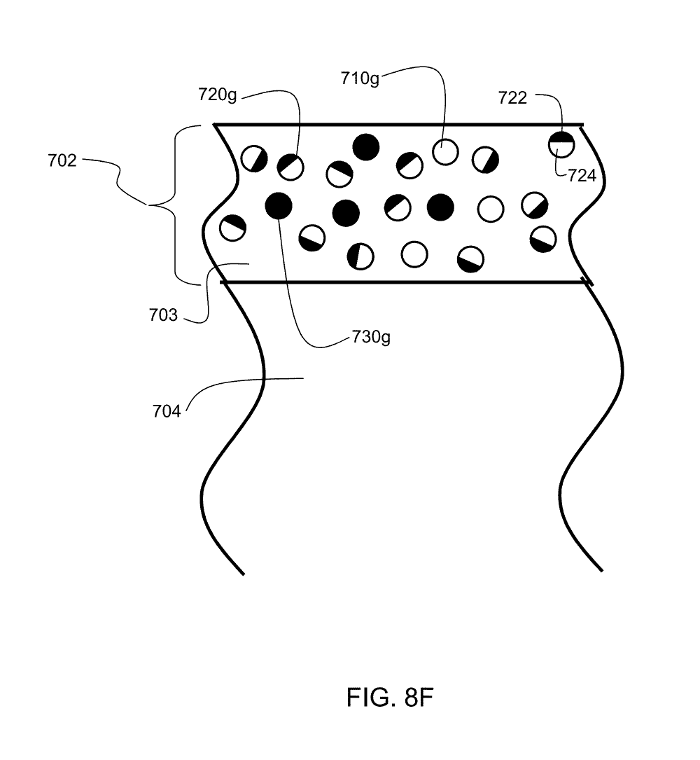

FIGS. 8A-8F shows detailed cross-section views of a multilayered composite material utilizing a scattering agent in accordance with some embodiments. FIGS. 8A-8F show a small area approximated by region 706 of FIG. 7, to provide further details of the polymer surface layer 702. Referring now to FIG. 8A, the polymer surface layer 702 is disposed on prepreg fiber tape 704. The polymer surface layer 702 comprises a scattering agent that includes a plurality of particles, examples of which are pointed out at 710a, 710b, 710c, disposed within a polymer layer 703. The particles may be substantially spherical, and have a diameter D and outer surface 712. In some embodiments, the scattering agent comprises particles having a diameter ranging from 0.1 micrometers to 2 micrometers. The diameter D may be selected based on the intended energy source used to heat the polymer surface layer. For example, in the case of a 1.06 micrometer infrared light source, a particle diameter D of 1.2 to 2 micrometers may be used. The selected diameter may be slightly larger than the Mie scattering value in certain embodiments. In some embodiments, the amount of the scattering agent that is added to the polymer 703 is such that the scattering agent comprises a constituent fraction ranging from about 0.1% to 10% by weight.

FIG. 8B shows an incident light source L incident upon the polymer surface layer 702, the light then scatters when incident upon the particles, examples of which are pointed out at 710a, 710b, and 710c, that are dispersed within the polymer 703 of the polymer surface layer 702. The scattering light L′ then may be absorbed by the polymer 703, and/or the scattering light L′ may additionally be incident upon additional particles, e.g., 710d and 710e to scatter and absorb throughout more of the polymer 703, allowing a more even energy absorption.

FIG. 8C shows an additional embodiment using a scattering agent that has been treated with a paint, dye, or other coloring agent prior to dispersion into the polymer 703. In some embodiments, the scattering agent is treated with a light absorbing dye. Such dyes can be used to treat the scattering agent particles and the particles remain non-conducting. For example NIR 1072A dye from QCR Solutions Corp (Port St. Lucie, Fla.) exhibits maximum absorbance near 1.064 micrometers wavelength which is well suited for absorbing Nd:YAG laser light energy. In embodiments, the dye includes a cyanine-based compound. In such an embodiment, the scattering agent has an increased absorption component, but still provides some scattering as well. The increased absorption causes the particles, examples of which are pointed out at 730a, 730b, 730c, to become heated, further providing an even, distributed heating of the polymer surface layer 702.

FIG. 8D shows an additional embodiment using a scattering agent comprising particles, examples of which are pointed out at 720a, 720b, 720c, that have been directionally treated with a colorant such as a paint, dye, or other coloring agent prior to dispersion into the polymer 703. In such an embodiment, the scattering agent particles may be treated on one half of each spherical particle with a coloring agent such as a paint or dye that is directionally applied to the particles 720a-720c before the particles are introduced to the polymer 703. As a result of the directional application, each particle 720a-720c has an absorbing side 722 and a scattering side 724. The scattering agent thus provides both absorbing and scattering capability. The particles may then be introduced to into the polymer such that the particles are randomly oriented with regards to the position of the scattering side and absorbing side of each particle.

FIG. 8E shows an additional embodiment using a scattering agent that includes a mixture including untreated particles, an example of which is pointed out at 710f, and color-treated particles, an example of which is pointed out at 730f. In such an embodiment, the scattering agent provides a combination of both scattering and absorption. The ratio of color-treated particles to untreated particles may be adjusted to control the amount of scattering and/or absorption. In some embodiments, the ratio of color-treated particles to untreated particles may be approximately 1:1. In other embodiments, the ratio of color-treated particles to untreated particles may be approximately 3:7, to provide more scattering than absorption. In other embodiments, the ratio of color-treated particles to untreated particles may be approximately 7:3, to provide more absorption than scattering. Other ratios are possible and within the scope of embodiments of the present invention.

FIG. 8F shows an additional embodiment using a scattering agent that includes a mixture including untreated particles, an example of which is pointed out at 710g, color-treated particles, an example of which is pointed out at 730g, and directionally treated (partially color-treated) particles, an example of which is pointed out at 720g. In such an embodiment, a combination of absorption and scattering is achieved, and the amount of scattering and absorption is controllable by adjustment of the mixture of scattering agent particles in the polymer surface layer 702. Through experimentation and/or computer simulation, a suitable amount of each particle type can be determined for a given polymer 703 and energy source.

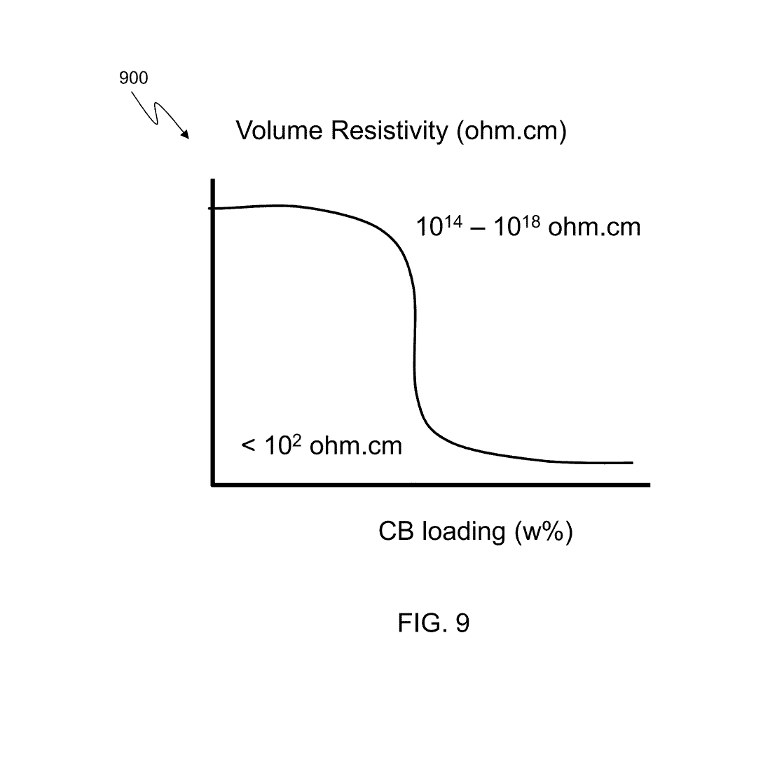

FIG. 9 is a graph 900 showing a relationship between volume resistivity and carbon black content. As can be seen, the volume resistivity decreases sharply with the introduction of carbon black. Thus, embodiments of the present invention utilize materials that may have a higher resistivity than carbon black, in order to maintain a higher resistivity of the material. This can produce a thermoplastic composite material well suited for applications where high resistivity is needed, such as antenna shielding.

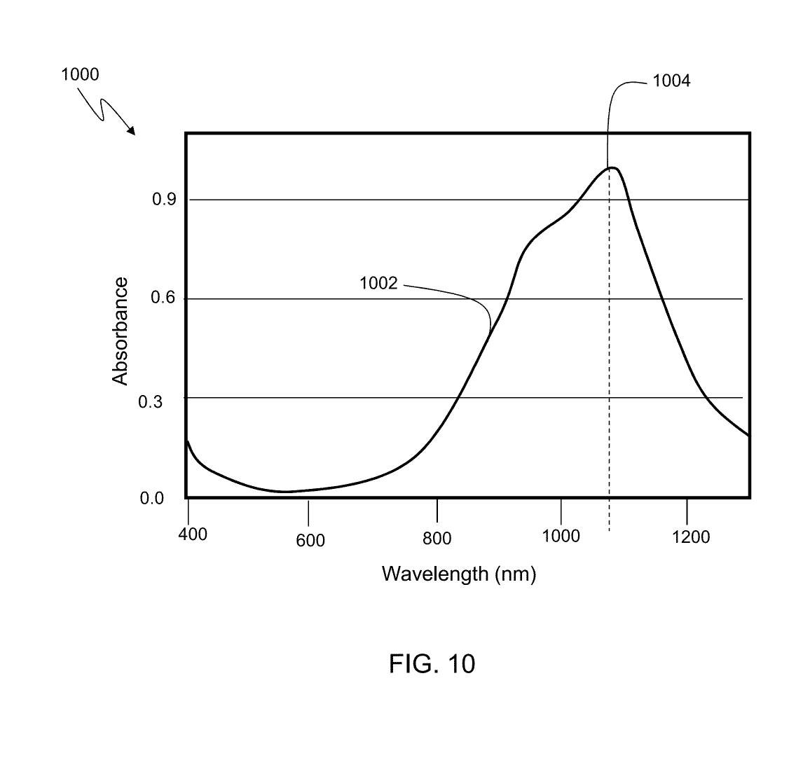

FIG. 10 is a graph 1000 showing a relationship between absorbance and wavelength for dyed particles. As can be seen by the graph, the curve 1002 has a peak 1004 indicating maximum absorption at a given wavelength. In this example, the optimal wavelength is approximately 1,060 nanometers. Hence, an energy source at or near this wavelength can produce good results in terms of absorption.

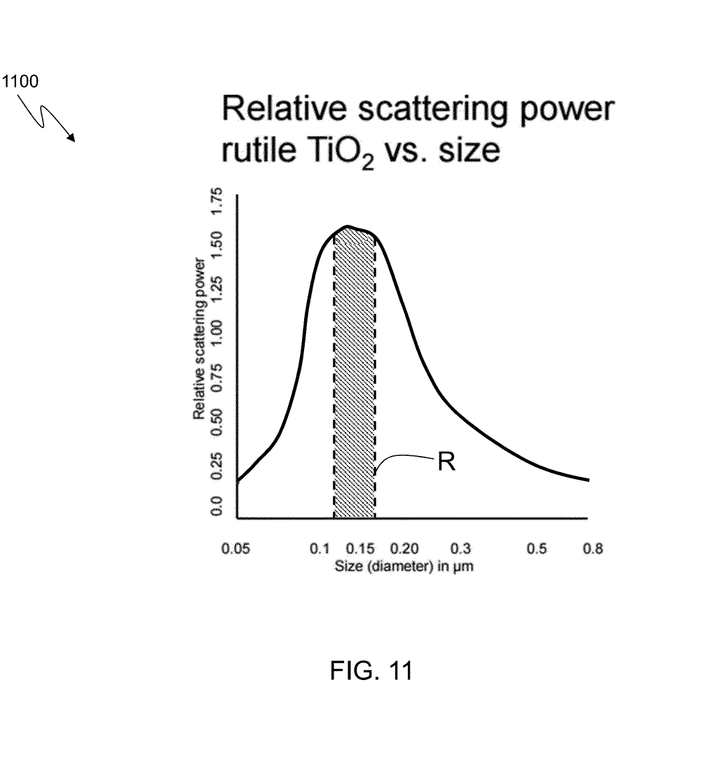

FIG. 11 is a graph 1100 showing scattering power as a function of particle size for rutile titanium oxide. As can be seen in this chart, an optimal diameter range R ranges from about 0.11 micrometers to about 0.16 micrometers. The optimal particle size may depend on the material type, crystalline structure of the material, and other factors.

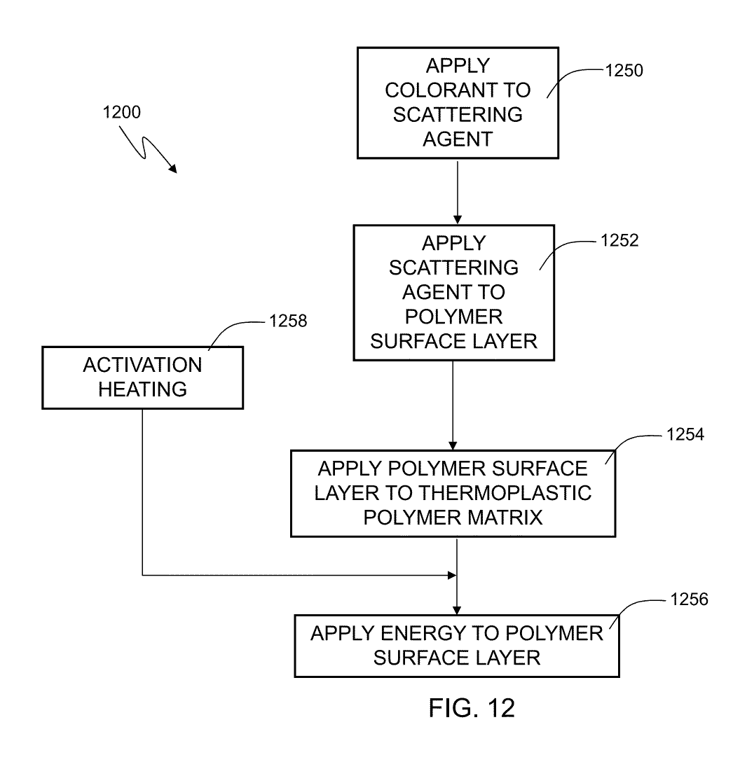

FIG. 12 is a flowchart 1200 indicating process steps for embodiments of the present invention. In process step 1250, a colorant is optionally applied to the scattering agent. In some embodiments, process step 1250 may be skipped, and the process starts with step 1252 of applying the scattering agent to a polymer surface layer. In process step 1254, the polymer surface layer is applied to a thermoplastic polymer matrix that is part of a prepreg fiber tape. In process step 1256, energy is applied to the polymer surface layer to induce scattering and absorption. In some embodiments, laser energy in a wavelength of 0.5 micrometers to 3.0 micrometers is used. In embodiments, the polymer surface layer is heated to a temperature ranging from about 130 degrees Celsius to about 500 degrees Celsius to manufacture a composite part using a mandrel and an automated fiber placement apparatus. Using such an apparatus, a plurality of multilayered composite material windings are applied to a mandrel. The mandrel may be in a desired shape for a part, such as beam, airfoil, or other composite that it is desired to fabricate from a composite material. In embodiments, the laser may be applied to the polymer surface layer for a duration ranging from about 0.01 seconds to about 1 second.

Referring again to step 1252, in some embodiments, the scattering agent may include a thermochromic material. Temperature change causes thermochromic materials to change color and thermotropic materials to change transparency. In embodiments, such materials are used to advantageously improve thermoplastic composite prepreg conditions for automated fiber placement. In embodiments, the use of such materials serves to improve the energy absorbing properties of the prepreg to provide a more consistent temperature and uniform temperature distribution. For example, a negative thermochromic (color change such that less laser light is absorbed) or negative thermotropic (less transparent to laser light) reversible (reverts back to its original state after cooling) filler or pigment may be used to control the temperature during laser heating. There are a number of materials that exhibit these properties. For example, α-alumina (Al₂O₃) with 1% amount Cr³⁺ ions in place of Al³⁺ ions results in a thermochromic material with a transition temperature at 450 degrees Celsius. Such a material may be used to automatically fiber place PEEK polymer composite materials where 450 degrees Celsius may be used as the processing temperature. In other embodiments, the materials may include leuco dyes and poly Phenylene Vinylenes. The thermochromic material may change color and thus, absorption and scattering (reflective) properties based on temperature. In such embodiments, the process may optionally include an activation heating step 1258 prior to application of the energy to the polymer surface layer in step 1256. The activation heating may be used to change the thermochromic scattering agent to its ideal color prior to application of the energy. In embodiments, the activation heating occurs at a process temperature ranging from about 100 degrees Celsius to about 250 degrees Celsius. In embodiments, the thermochromic scattering agent may include particles comprising a-alumina (Al₂O₃) with 1% of Cr³⁺ ions in place of Al³⁺ ions. In other embodiments, the scattering agent may include a thermotropic material. In some embodiments, the thermotropic scattering agent may be comprised of Poly Phenylene Vinylene (PPV).

While the invention has been particularly shown and described in conjunction with exemplary embodiments, it will be appreciated that variations and modifications will occur to those skilled in the art. In particular regard to the various functions performed by the above described components (assemblies, devices, circuits, etc.) the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application. Moreover, although some illustrative embodiments are described herein as a series of acts or events, it will be appreciated that the present invention is not limited by the illustrated ordering of such acts or events unless specifically stated. Some acts may occur in different orders and/or concurrently with other acts or events apart from those illustrated and/or described herein, in accordance with the invention. In addition, not all illustrated steps may be required to implement a methodology in accordance with the present invention. Furthermore, the methods according to the present invention may be implemented in association with the formation and/or processing of structures illustrated and described herein as well as in association with other structures not illustrated. Therefore, it is to be understood that the appended claims are intended to cover all such modifications and changes that fall within the true spirit of the invention.

What is claimed is:

1. A multilayered composite material suitable to be bonded by a laser, comprising:
a prepreg fiber tape comprising fibers held together with a thermoplastic polymer matrix;
a polymer surface layer disposed on the prepreg fiber tape; and
a scattering agent disposed within the polymer surface layer, wherein the scattering agent comprises a plurality of discrete particles that are substantially uniformly distributed throughout the polymer surface layer, and wherein the polymer surface layer and the thermoplastic polymer matrix are comprised of an identical polymer.

2. The multilayered composite material of claim 1, wherein the polymer surface layer is melt miscible with the thermoplastic polymer matrix.

3. The multilayered composite material of claim 1, wherein the scattering agent comprises alumina (Al₂O₃).

4. The multilayered composite material of claim 1, wherein the scattering agent comprises titanium dioxide (TiO₂).

5. The multilayered composite material of claim 1, wherein the scattering agent comprises silica (SiO₂).

6. The multilayered composite material of claim 1, wherein the scattering agent comprises glass microballoons.

7. The multilayered composite material of claim 1, wherein the scattering agent comprises particles having a diameter ranging from 0.1 micrometers to 2 micrometers.

8. The multilayered composite material of claim 1, wherein the scattering agent is thermochromic.

9. The multilayered composite material of claim 8, wherein the scattering agent comprises a-alumina (Al²O³) with 1% of Cr³⁺ ions in place of Al³⁺ ions.

10. The multilayered composite material of claim 1, wherein the scattering agent comprises a constituent fraction ranging from about 0.1% to 10% by weight.

11. The multilayered composite material of claim 1, wherein the scattering agent is thermotropic.

12. The multilayered composite material of claim 11, wherein the thermotropic scattering agent is Poly Phenylene Vinylene (PPV).

13. The multilayered composite material of claim 1, wherein the scattering agent comprises particles treated with a light absorbing dye.

14. The multilayered composite material of claim 13, wherein the light absorbing dye includes a cyanine-based compound.

15. The multilayered composite material of claim 1, wherein the scattering agent comprises particles that are directionally-treated with a colorant.

16. The multilayered composite material of claim 1, wherein the scattering agent comprises a mixture of untreated particles and color-treated particles.

17. The multilayered composite material of claim 16, wherein the scattering agent further comprises particles that are directionally-treated with a colorant.

18. A method of forming a composite object comprising:
applying a plurality of multilayered composite material windings to a mandrel, wherein the plurality of multilayered composite material windings comprise:
a prepreg fiber tape comprising fibers held together with a thermoplastic polymer matrix;
a polymer surface layer disposed on the prepreg fiber tape; and
a scattering agent disposed within the polymer surface layer, wherein the scattering agent comprises a plurality of discrete particles that are substantially uniformly distributed throughout the polymer surface layer, and wherein the polymer surface layer is comprised of the same polymer as the thermoplastic polymer matrix;
applying laser energy to the multilayered composite material as it is applied to the mandrel; and
compacting the multilayered composite material after the laser energy has been applied.

19. The method of claim 18, wherein applying laser energy comprises applying laser energy with a wavelength ranging from 0.5 micrometers to 3 micrometers.

20. The method of claim 19, further comprising heating the multilayered composite material to a temperature ranging from about 130 degrees Celsius to about 500 degrees Celsius.

21. The method of claim 19, wherein applying laser energy comprises applying laser energy for a duration ranging from 0.1 seconds to 1 second.

22. A method of making a multilayered composite material, comprising:
applying a scattering agent to a polymer to be used as a polymer surface layer; and
applying the polymer surface layer to a prepreg fiber tape comprising fibers held together with a thermoplastic polymer matrix, wherein the thermoplastic polymer matrix and the polymer surface layer comprise an identical polymer.

23. The method of claim 22, wherein applying a scattering agent comprises applying alumina (Al₂O₃).

24. The method of claim 22, wherein applying a scattering agent comprises applying titanium dioxide (TiO₂).

25. The method of claim 22, wherein applying a scattering agent comprises applying thermochromic material.
